(19) United States
(12) Patent Application Publication
(10) Pub. No.: US 2003/0135409 A1
(43) Pub. Date: Jul. 17, 2003

(54) Container/cover with a removable coupon/premium and a method for making the same

(76) Inventor: Elizabeth A. Romano, Lawrence, KS (US)

Correspondence Address: William B. Kircher, SHOOK, HARDY & BACON L.L.P., 1200 Main Street, Kansas City, MO, 64105-2118, US

(21) Appl. No.: 10/050,769

(22) Filed: Jan. 16, 2002

(51) Int. Cl. G06F 17/60; G09F 3/00

(52) U.S. Cl. 705/14; 40/307

(57) ABSTRACT

An enclosure having a tear away portion thereon representing a coupon, promotion, prize or other advertisement and a method for making the same is provided. The cover includes a first layer, a second layer and a removable piece. The first layer is adapted to protectively shield and retain the product within the interior portion of the container. The second layer is adapted to overlay the first layer and further includes a weakened portion. The removable piece is adapted to be integrated with the second layer and may be separated from the second layer by breaking weakened scored portion and tearing away the removable piece from the second layer while leaving the first layer to retain the contents within the interior portion of the container. The removable piece may be used as a premium, coupon, prize or other type of advertisement.

### STATEMENT REGARDING FEDERALLY SPONSORED RESEARCH OR DEVELOPMENT

Not Applicable.

### CROSS-REFERENCE TO RELATED APPLICATIONS

Not Applicable.

### BACKGROUND OF THE INVENTION

This invention relates to a container/cover having a removable coupon thereon and, more particularly, to a coupon or premium that can be removed from the container/cover thereby permitting the viewing of the contents within the enclosure after the coupon is removed.

Printing advertisements on the exterior surface of packaging to promote a product is common and has been done for many years. In addition, promotions, premiums, or coupons are sometimes affixed to the exterior surface of the packaging. A coupon is typically affixed to a package with glue or tape and extends outwardly therefrom. This particular method of attaching coupons to packaging suffers from various drawbacks. For example, since the coupon extends outwardly from the surface of the package, there is a tendency for the coupon to be separated from the packaging when it catches on another package during shipping or when the package shifts and rubs against another package after being placed in a shopping cart.

Various attempts have been made to change the way premiums, coupons or promotions are affixed to enclosures. For instance, some enclosures include a coupon or prize that is concealed within a portion of the enclosure. Typically, the prize is placed underneath the base of the enclosure and is retained by a support disk concealing the prize from an external environment. However, this design has a number of disadvantages. For instance, this design requires extra material that would not normally be used in packaging the product (i.e., the support disk) to hold and conceal the prize underneath the bottom of the enclosure. The extra material increases the manufacturing cost and assembly time. In addition, in order to access the prize, a portion of the enclosure may be destroyed which results in a waste of material.

Alternatively, some enclosures have been designed to affix thin coupons to the outside surface of the enclosure. This method of affixing coupons to enclosures also suffers various deficiencies. For example, additional material must be used that would not normally be used in constructing the enclosure. Specifically, two strips of material are positioned on opposite sides of a coupon to hold the coupon on to the enclosure. The use of the two holding strips increases manufacturing costs. Furthermore, the coupon is positioned so close to the enclosure, it is difficult to separate the coupon from the two strips and remove the coupon from the enclosure.

Accordingly, there remains a need in the packaging arts for a combination coupon and container/container cover that facilitates easy removal of the coupon therefrom. In addition, there remains a need for a container combination or container cover that allows for the easy removal of a coupon while minimizing the amount of material that is used to affix the coupon thereto. Further, there remains a need for a combination coupon and container/container cover whereby the coupon can be removed without destroying the container or the container cover and which allows for the viewing of the container contents after coupon removal. The primary object of this invention is to meet these needs.

### BRIEF SUMMARY OF THE INVENTION

More specifically, one of the objects of the present invention is to provide a cover or lid for a container which supports and carries a coupon or other advertisement to be removed therefrom.

Another object of the present invention is to provide a method for producing a container/container cover having a tear away portion thereon.

According to the present invention, the foregoing and other aspects are achieved by a cover for enclosing a product within an interior portion of a container. The cover includes and end board having a first layer, a second layer and a removable piece. The first layer is adapted to retain the product within the interior portion of the container. The second layer is adapted to be positioned on top of the first layer and exposed to an external environment. The removable piece is adapted to be integrated with the second layer and may be separated therefrom.

The present invention also provides an enclosure for a product. The enclosure includes a container and a cover The container has, at least, an interior portion and an open end. The open end is adapted so that products may be placed in the interior portion of the container. The cover is adapted to removably close the container by covering the open end thereof. As suggested above, the cover end board has a first layer is adapted to protectively shield and retain the product within the interior portion of the container. The second layer is adapted to overlay the first layer. The removable piece is adapted to be formed in the second layer and is capable of being selectively removed from the second layer.

The present invention also provides a method for providing a cover for enclosing a product within a container. The cover includes a first layer, a second layer, and a removable piece. The first layer adapted to be coupled to the cover being capable of retaining the product placed therein. The second layer includes a weakened portion and is adapted to be placed over the first layer and be coupled to the cover. The removable piece is integrated with the second layer may be removed from the second layer by breaking the weakened portion formed in the second layer. The method includes the steps of weakening a portion of said second layer, placing said second layer on top of said first layer, coupling said first and second layer to said container, and allowing for the removal of said removable piece from said second layer.

The invention further provides for a container for enclosing a product within an interior portion thereof. The container includes a first layer, a second layer and a removable piece. The first layer is adapted to retain the product within the interior portion of the container. The second layer adapted to be placed over the first layer and directed toward an external environment. The removable piece integrated in the second layer and is selectively removable from the second layer.

Additional objects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means and instrumentalities and combinations particularly pointed out in the appended claims.

### BRIEF DESCRIPTION OF THE SEVERAL VIEWS OF THE DRAWING

In the accompanying drawings which form a part of the specification and are to be read in conjunction therewith and in which like reference numerals are employed to indicate like parts in the various views:

FIG. 1 is a front perspective view of a container and a cover having a removable coupon partially peeled back in accordance with a preferred embodiment of the present invention;

FIG. 2 is a plan view of the cover illustrated in FIG. 1 with the perforations coupling the coupon to the second layer;

FIG. 3 is a cross-sectional view taken generally along line 3-3 of FIG. 1; and

FIG. 4 is a fragmentary front perspective view of the container and cover in FIG. 1 with the second layer separated from the first layer illustrating the location of the adhesive on the first layer.

### DETAILED DESCRIPTION OF THE INVENTION

The present invention is directed to a container and cover combination for enclosing a product while allowing for a coupon to be removed from the container and/or the cover. The particular embodiments described herein are intended in all respects to be illustrative rather than restrictive. Alternative embodiments will become apparent to those skilled in the art to which the invention pertains without departing from its scope.

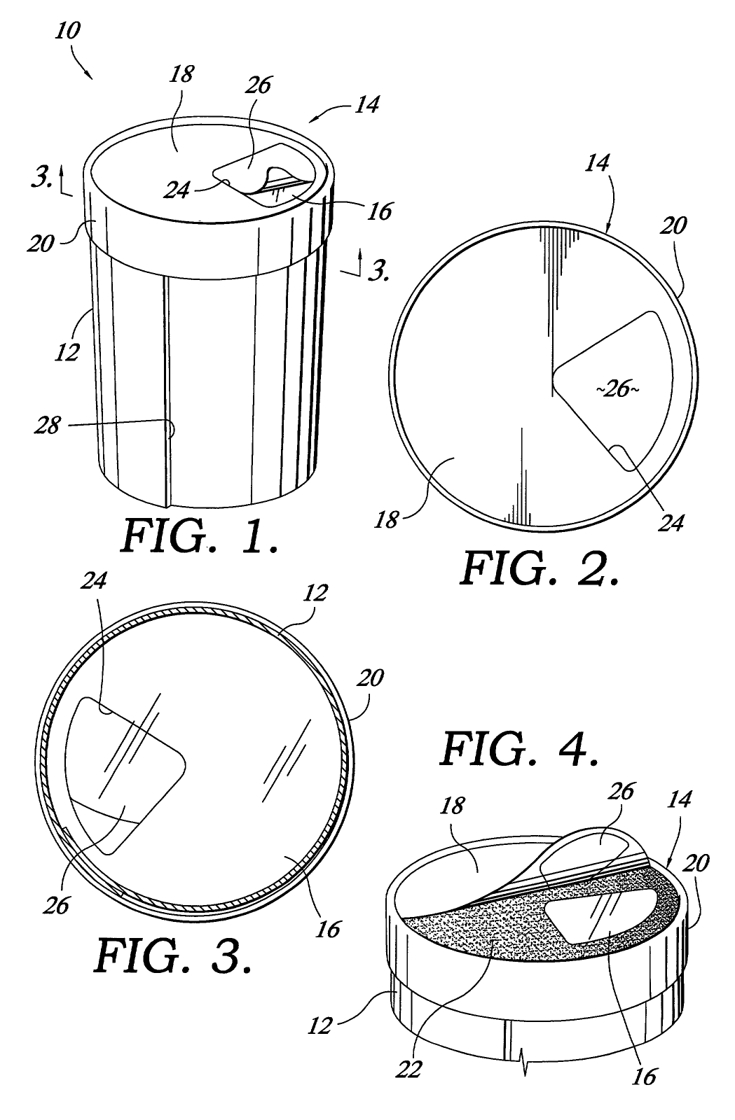

Referring to the drawings in general and initially to FIG. 1 in particular, an exemplary container/cover combination enclosure with an attached coupon is shown and designated generally by reference numeral 10. In its most basic configuration, the present invention includes a container 12 and a cover 14. Cover 14 may be removably or fixedly mounted to container 12 by any number of means known in the art. For example, cover 14 may be fastened to container 12 by a conventional friction force, using an adhesive or clip, or by fastening cover 14 to container 12 through the use of scores formed on the inside surface of cover 14. It will be understood and appreciated that even though the following description is directed to a cover enclosing one open end of container 12, the present invention can be utilized with other end portions or surfaces of container 12.

As best seen in FIG. 1, container 12 is used in combination with cover 14 to enclose a product within an interior portion of container 12. Container 12 is preferably formed of paperboard or plastic and is in the shape of a convolute cylinder as best seen in FIG. 1. It should be understood that container 12 could take various forms depending on the size, shape and consistency of the product being enclosed, the desired method of shipping, marketing considerations and other factors. For example, the cross-section of container 12 may be formed in the shape of an oval, square, rectangle, triangle, or any combination thereof. Container 12 may include a curled edge or rim, not shown, that is adapted to frictionally accept cover 14. The peripheral edge or rim defines an opening where a product can be placed within or removed from container 12. Examples of paperboard containers that are constructed in a similar fashion, with exception of the discoidal end portions, are described in U.S. Pat. No. 4,432,473 to MacEwen and U.S. Pat. No. 4,830,231 to Smith, which are herein incorporated by reference.

As best seen in FIGS. 1, 2 and 3, cover 14 has a discoidal end which includes a first layer 16, a second layer 18 and a cover ring or skirt 20 that positions and connects the cover to container 12. In addition to its conventional function, cover 14 allows for the selective removal of a premium, coupon or promotion which will be more fully described below. Likewise, a fixed non-removable end portion of the container coupled be adapted to display and include the premium/coupon.

As best seen in FIGS. 3 and 4, first layer 16 is preferably formed of a film material that may contact the product within container 12. The film used to form first layer 16 is preferably transparent and as will be seen, allows a user to view the contents contained within container 12. It should be understood that it is within the scope of this invention to form first layer 16 of paperboard, plastic, aluminized material, or any polymeric material that is transparent, translucent or opaque as long as it is capable of retaining the product contained within the interior portion of container 12. The peripheral edge of first layer 16 is adapted to contact and/or be sealed with the peripheral edge of container 12 as best seen in FIG. 3. As best seen in FIG. 4, first layer 16 may include an adhesive 22 placed thereon to couple first layer 16 to second layer 18. Adhesive 22 can be any type of glue, tape, fastener or the like that will couple first layer 16 to second layer 18. While first and second layers 16, 18 may be laminated over their entire surfaces, these layers may also rest on top of one another and be affixed only at their peripheral edge portions.

As best seen in FIGS. 2 and 4, second layer 18 is positioned on top of first layer 16 and may be exposed to the external environment. While second layer 18 could have various shapes, it is preferably the same shape as first layer 16.

A weakened scored portion or perforations 24 are formed in second layer 18 and define a removable piece 26. Piece 26 is flush with second layer 18 and does not protrude or extend outwardly from layer 18 prior to the weakened portion 24 being broken. In other words, piece 26 is a part of and integrated into second layer 18 so a separate fastening means is not required to affix piece 26 to the outside surface of second layer 18. Perforations 24 are adapted to be broken so that piece 26 can be peeled away from and become separated from second layer 18. Piece 26 can be used as a premium, coupon, prize, game piece, promotional stickers and the like. Pieces 18 can be various shapes and sizes and is not limited to the generally triangular shape as illustrated in FIG. 2.

In the alternative, an aperture could be formed in second layer 18 in the shape and size of the removable piece 26 so that piece 26 could be placed in aperture and rest flush with second layer 18. Piece 26 could then be retained in the aperture using several means whether held by an adhesive or otherwise would be easily removed or detached from second layer 18.

Returning to the preferred embodiment, second layer 18 is formed of paperboard, but it should be understood that other types of materials could be used including, but not limited to, plastic, aluminized material or any other polymeric material that is capable of being manufactured to include perforations or a weakened portion 24. In addition, the material used to form second layer 18 is capable of being printed on both its upper and lower surface portions. Printing on the upper surface of second layer 18 allows for premiums, coupons, advertisements and stickers to be exposed to an external environment. The lower (or inner) surface of second layer 18 may contain printing and be used as a prize, coupon or for another purpose. In that manner, first layer 16 operates as a functional barrier protecting the product within container 12 from being contaminated from ink or other chemicals used to print on second layer 18. Further, the lower surface of second layer 18 adheres to the adhesive material 22 that is placed on the top portion of first layer 16 to insure a unitary discoidal end portion.

As best seen in FIGS. 2 and 4, cover ring or skirt 20 is preferably formed of paperboard or plastic with first and second layers 16, 18 integrally connected thereto by conventional means such as adhesives, hot melts, sonic welding or by interconnecting folded peripheral edges. As mentioned above, the outer surface of skirt 20 is shaped in the form of a ring frictionally extends over the peripheral edge of container 12 to fasten cover 14 thereto. If necessary, the skirt 20 may be taped or otherwise sealed to the side wall of container 12. In addition, the upper edge of skirt 20 includes an inner-curl and a suitable location for affixing the discoidal end by compressing first and second layers 16, 18 thereto with an adhesive or other type of fastening device. An example of a folded end construction for securing an end disk to a dispensing cartridge is described in pending U.S. patent application Ser. No. 09/732,065 filed on Dec. 7, 2000, which is herein incorporated by reference.

In an alternative embodiment, a score or ridge (not shown) may be formed around the interior circumference extending from the inside surface of skirt 20 below the inner-curl so that first and second layers 16, 18 may be supported between the inner-curl and the score. An additional score may also be added below the first score to removably couple cover 14 to the outcurl on the upper portion of the rim of container 12. In still another embodiment, instead of coupling first and second layers 16, 18 to inner-curl, the edge opposite of the inner-curl 20 may be folded so that it is positioned against the interior surface of skirt 20 to form an annular groove for first and second layers 16, 18 to be supported on the top of the ridge of the folded portion or within the groove formed by the fold. In either embodiment, second layer 18 may be recessed so that the rib structure will endure the wear and tear that could occur during shipping and handling.

A weakened portion is formed in second layer 18 to form the size and shape of the removable piece 26. As best seen in FIG. 4, an adhesive 22 is applied to the top surface of first layer 16 in a pattern coat throughout its entire area excluding the portion where removable piece 26 will be placed over first layer 16. Second layer 18 is positioned on top of first layer 16 so that adhesive 22 couples first and second layers 16, 18 to one another, except in the area where piece 26 is in contact with first layer 16. First and second layers 16, 18 are preferably the same size and are slightly smaller than the inside peripheral edge of skirt 20 so that first and second layers 16, 18 may fit therein.

First and second layers 16, 18 are then coupled to skirt 20 to form cover 14. In particular, first and second layers 16, 18 fit within skirt 20 and positioned so that second layer 18 is coupled to the inner-curl formed in the rim of skirt 20. Second layer 18 may be coupled to skirt 20 by an adhesive or other fastening member. The opposite open end of container 12 may be sealed by using cover 14 as described above or by any other means known in the art.

In operation, various types of products may be placed within the interior portion of container 12, and cover 14 may be slid onto the end of container 12 to retain the contents within container 12. Specifically, first layer 16 operates to seal the product within container 12. Second layer 18 may be printed on both sides to describe the contents of the product contained within container 12, provide a premium or prize, or permit further advertising thereon. Further, second layer 18 holds piece 26 in place until it is removed. Prior to removing piece 26, if a transparent or translucent type material is used for first layer 16, second layer 18 serves as a barrier to protect the product contained within the interior portion of container 12 from damage or spoiling that might occur due to sunlight exposure or by other causes.

In order to remove piece 26 from second layer 18, weakened portion or perforations 24 are broken or punched through to allow for the removal or tearing-away of piece 26 from second layer 18. To facilitate this task, a lifting tab may be affixed to the upper surface of piece 26 or and edge of the piece, usually at the corner, will be fully severed to accommodate lifting and removing of piece 26. After second layer 18 is broken along the weakened portion 24, first layer 16 continues to retain the product contained in the interior portion of container 12. As best seen in FIGS. 1 and 3, piece 26 is peeled back or torn away from second layer 18 since there is no adhesive 22 coupling piece 26 to first layer 16. The absence of adhesive 22 on first layer 16 in the area where first layer 16 is in contact with piece 26 prevents the peeling away and destruction of first layer 16 when piece 26 is peeled or torn away from second layer 18. First layer 16 continues to retain the product within container 12 until cover 14 is removed or slid off of container 12.

Once the weakened portion 24 is broken and piece 26 is detached from second layer 18, piece 26 may be used as a premium, coupon, prize, game piece, advertisement and the like. Other than breaking perforations 24 to remove piece 26 from second layer 18, it is not necessary to destroy container 12 or cover 14 to remove piece 26. An aperture remains in second layer 18 after piece 26 is peeled away from second layer 18. The transparent or translucent nature of first layer 16 permits a user to view the product within the container 10 through the aperture once piece 26 is removed from second layer 18.

It is contemplated that the discoidal end with the coupon could be integrally formed in an end portion or a side portion of container 12 rather than in cover 14 without departing from the scope of this invention.

Constructed and operated as previously described, this invention provides a unique container/cover/coupon combination or a coupon/container combination and a unique method of using the same. The present invention has been described in relation to particular embodiments which are intended in all respects to be illustrative rather than restrictive. Alternative embodiments will become apparent to those skilled in the art to which the present invention pertains without departing from its scope.

From the foregoing, it will be seen that this invention is one well-adapted to attain the ends and aspects hereinabove set forth together with other advantages which are obvious and inherent to the structure. It will be understood that certain features and subcombinations are of utility and may be employed without reference to other features and subcombinations. This is contemplated by and is within the scope of the claims.

Having thus described the invention, what is claimed is:

1. A cover for enclosing a product within an interior portion of a container, said cover comprising:
a first layer adapted to retain the product within the interior portion of the container;
a second layer adapted to be positioned over said first layer and directed toward an external environment, wherein a portion of said second layer is adapted to be separated from said second layer; and
a removable piece integrated with said second layer and adapted to be separated from said second layer, wherein said removable piece represents a coupon, premium, promotion or other advertisement.

2. The cover as recited in claim 1, wherein said second layer includes a weakened portion that couples said removable piece to said second layer.

3. The cover as recited in claim 2, wherein said weakened portion is formed of perforations.

4. The cover as recited in claim 1, further comprising:
a skirt adapted to removably couple said first and second layer to the container.

5. The cover as recited in claim 1, wherein said first layer is adhesively coupled with said second layer.

6. The cover as recited in claim 5, wherein said first layer is adhesively coupled with said second layer in an area surrounding said removable piece.

7. The cover as recited in claim 1, wherein said first layer is formed of a transparent material.

8. An enclosure for a product having a coupon, premium, promotion or other advertisement integrally formed therein, said enclosure comprising:
a container including an interior portion and an open end, wherein the open end is adapted so that the product may be placed in said interior portion of said container; and
a cover adapted to be coupled with said container and cover said open end of said container, said cover comprising:
a first layer adapted to retain the product within said interior portion of said container;
a second layer adapted to be placed over said first layer and directed toward an external environment; and
a removable piece integrated in said second layer, wherein said removable piece is selectively removable from said second layer.

9. The enclosure as recited in claim 8, further comprising:
a cover ring adapted to removably couple said first and second layer to said container.

10. The enclosure as recited in claim 8, wherein said first layer is adhesively coupled with said second layer.

11. The enclosure as recited in claim 10, wherein said first layer is adhesively coupled with said second layer in the area surrounding said removable piece.

12. The enclosure as recited in claim 8, wherein said first layer is formed of a transparent material.

13. The enclosure as recited in claim 8, wherein said removable piece is retained to said second layer by perforations.

14. A method for providing a coupon, promotion, premium or other advertisement on an enclosure for a product, wherein said enclosure includes a container and a lid, and wherein said lid includes a first layer and a second layer, said method comprising:
weakening a portion of said second layer to form a removable piece;
positioning said second layer over said first layer;
coupling said first and second layers to said container to retain the product within said container, wherein said portion of said second layer is directed toward an external environment; and
allowing for the removal of said removable piece from said second layer.

15. The method of claim 14, further comprising:
providing for a cover ring, wherein said cover ring is used to couple said first and second layers to said container.

16. The method of claim 14, further comprising:
adhesively coupling said first and second layers to one another before coupling said first and second layers to said container.

17. The method of claim 14, further comprising:
adhesively coupling said first and second layers to one another in the area surrounding the portion where the removable piece is over said first layer before coupling said first and second layers to said container.

18. The method of claim 14, further comprising:
breaking the weakened portion of said second layer; and
removing said removable piece from said second layer, wherein said first layer retains the product within the container.

19. The method of claim 18, wherein said first layer is formed of a material that allows for the viewing of the product within said container after removing said removable piece from said second layer.

20. A cover used for advertisement or promotion, wherein said cover is adapted to enclose a product within an interior portion of a container, said cover comprising:
a first layer adapted to retain the product within the interior portion of the container;
a second layer adapted to be positioned over said first layer and directed toward an external environment; and
means for selectively removing a portion of said second layer.

21. The cover as recited in claim 20, further comprising:
means for viewing the product within the interior portion of the container.

22. The cover as recited in claim 20, further comprising:
means for coupling said first and second layers to the container.

23. A container for a product, said container comprising:
a first layer adapted to retain the product within an interior portion of said container;
a second layer adapted to be placed over said first layer and directed toward an external environment; and
a removable piece integrated in said second layer, wherein said removable piece is selectively removable from said second layer.

24. The container as recited in claim 23, wherein said second layer includes a weakened portion that couples said removable piece to said second layer.

25. The container as recited in claim 24, wherein said weakened portion is formed of perforations.

26. The container as recited in claim 23, wherein said first layer is adhesively coupled with said second layer.

27. The container as recited in claim 26, wherein said first layer is adhesively coupled with said second layer in an area surrounding said removable piece.

28. The container as recited in claim 23, wherein said first layer is formed of a transparent material.

29. The container as recited in claim 23, further comprising:
a cover adapted to enclosed the product within said interior portion of the container.
